(19) United States
(12) Patent Application Publication
(10) Pub. No.: US 2007/0181159 A1
(43) Pub. Date: Aug. 9, 2007

(54) DISK CLEANING APPARATUS, DISK IMMERSING AND EXTRACTING MECHANISM AND DISK CLEANING METHOD

(75) Inventors: SHINGO IBE, KANAGAWA (JP); NORITAKE SHIZAWA, KANAGAWA (JP); TATSUO KANEKO, KANAGAWA (JP)

Correspondence Address: J C PATENTS, INC., 4 VENTURE, SUITE 250, IRVINE, CA, 92618, US

(73) Assignee: HITACHI HIGH-TECHNOLOGIES CORPORATION, TOKYO (JP)

(21) Appl. No.: 11/669,443

(22) Filed: Jan. 31, 2007

(30) Foreign Application Priority Data
Feb. 3, 2006 (JP) 2006-027025

(51) Int. Cl. B08B 9/20; B08B 3/00; C23G 1/00

(52) U.S. Cl. 134/25.1; 134/56 R; 134/58 R; 134/135; 134/61; 134/2

(57) ABSTRACT

A disk immersing and extracting mechanism is provided, which utilizes a floating-control means to control a disk, so as to prevent the disk from floating up or falling over in the rinse tank and to prevent liquid droplets from dripping from the floating-control means onto the disk to cause an undesired cleaning. In the present invention, a disk is immersed into a rinse tank by a disk holder, and then, the cleaned disk is extracted out of the rinse tank. The disk holder comprises a control bar on the upper side, and a disk support frame on the lower side that has a pair of tooth plates parallel to the control bar.

### CROSS-REFERENCE TO RELATED APPLICATION

This application claims the priority benefit of Japan application serial no. 2006-027025, filed Feb. 3, 2006. All disclosure of the Japan application is incorporated herein by reference.

### BACKGROUND OF THE INVENTION

1. Field of the Invention

The present invention relates to a disk cleaning apparatus, a disk immersing and extracting mechanism, and a disk cleaning method. More particularly, the present invention relates to a disk cleaning apparatus, a disk immersing and extracting mechanism, and a disk cleaning method, in which a rinse solvent is used to perform the ultrasonic cleaning in a cleaning apparatus with a circulated chemical agent to remove the dirt on a disk (disc) such as a magnetic disk, a magnetic disk substrate, an optical disk, and a wafer, and particularly, a floating-control means is used to control the disk and to prevent the disk from floating or falling over in the rinse tank, and liquid droplets are also prevented from dripping from the floating-control means to the disk to cause an undesired cleaning of the disk.

2. Description of Related Art

As for a substrate of a hard disk, for example, after a process of grinding, polishing, sputtering, and plating, etc., the disk is generally cleaned with a chemical agent. Cleaning such a disk (for example, hard disk and wafer) with a chemical agent includes a plurality of cleaning steps and also drying steps after cleaning.

Generally, during the cleaning process, it is already known that a rinse tank (or a cleaning apparatus) is used, in which a cassette or a carrier (or tray) having a plurality of disks vertically arranged is immersed therein into a cleaning liquid, and the disks are cleaned by ultrasonic waves. Under this situation, the drying of the disks after cleaning is achieved by conveying the cassette or the carrier (or tray) into a drying chamber and drying therein.

In Japanese Patent Laid-Open Publication No. 2001-96245, a scrubbing apparatus is disclosed, which is used to replace the disk holder for cleaning disks, and particularly, a conveyer apparatus, such as a conveyer belt is respectively disposed in a shower rinse tank, a chemical agent rinse tank, an ultrasonic rinse tank, and a purified water rinse tank, and the disk is conveyed into each tank by the conveyer belt, which allows the disk to move sequentially in each tank for being cleaned.

When cleaning a disk in the ultrasonic rinse tank, a solvent, such as for rinsing, etc., is used as a chemical agent. In a cleaning apparatus using such a chemical agent, the chemical agent is usually circulated as follows. For example, a chemical agent tank and an ultrasonic rinse tank are disposed parallel to each other, and the overflowing chemical agent flows back to the chemical agent tank. Japanese Patent Laid-Open Publication No. 2002-157240 discloses a disk cleaning method and a cleaning apparatus using the above circulation manner.

Currently, the hard disk has been widely used in the fields of automobile products, home appliance products, and audio-video products, and hard disk drives (HDD) of 2.5 inches to 1.8 inches, and less than or equal to 1.0 inch, for example, 0.85 inches are used, and the HDD itself is getting smaller and smaller. Moreover, a glass disk, which is a disk substrate uses glass, has the thickness of about 0.5 mm. Compared with a wafer and a disk in the prior art, the weight of the disk is very light, which is only about several grams. Therefore, when cleaning and immersing the disk in the cleaning liquid, or extracting the disk out of the cleaning liquid, the problem that the disk itself may float up or falls over easily occurs.

Especially in the cleaning apparatus with circulated chemical agent, as the cleaning liquid flows, the disk itself tends to float upwards, or fall over; as a result, the neighboring disks come in contact with each other or the disk support means contacts with the disk, which is the reason that causes a part of the disk to be damaged or causes a poor cleaning effect.

Accordingly, a technology for controlling and cleaning a disk or wafer by using a control rod or control bar is proposed, for preventing the disk or wafer from floating up. The technology is disclosed in Japanese Patent Laid-Open Publication No. 8-10735, Japanese Patent Laid-Open Publication No. 6-52144 and Japanese Patent Laid-Open Publication No. 11-354408.

If the disk is controlled by using a rod or bar, the disk handling treatment by using a disk chuck, etc. will be hampered when moving the disk into or out of the cleaning apparatus. Therefore, as described in Japanese Patent Laid-Open Publication No. 8-10735, Japanese Patent Laid-Open Publication No. 6-52144, and Japanese Patent Laid-Open Publication No. 11-354408, if a disk control means is disposed in a rinse tank or over a disk, the disk control means must be bypassed when performing the handling treatment of carrying a disk into and out of the rinse tank.

In the other aspect, when the disk is 2.5 inches to 1.8 inches, and furthermore less than or equal to 1.0 inch, due to the fact that the cleaning is not performed in a single row, but in a plurality of rows, it is difficult to use the above cleaning manner as disclosed in Japanese Patent Laid-Open Publication No. 6-52144 and Japanese Patent Laid-Open Publication No. 11-354408. For example, disposing a disk control means (or a wafer control means) over a disk or a wafer, and controlling each row of disks from the upper part. Additionally, liquid droplets easily drip from the control means over the disk, which results in the problem of a poor cleaning of disks.

As disclosed in Japanese Patent Laid-Open Publication No. 8-10735, if a disk control means is disposed in a rinse tank, a means of the handling robot must be immersed in the rinse tank, so that the cleaning liquid or the disk is easily contaminated.

Furthermore, if the control mechanism is disposed within the rinse tank, the area occupied by the rinse tank must be enlarged.

### SUMMARY OF THE INVENTION

Accordingly, in view of the above problems in the prior art, the present invention is directed to a disk immersing and extracting mechanism, which uses a floating-control means to control a disk, so as to prevent the disk from floating up or falling over in the rinse tank, and also prevent liquid droplets from dripping from the floating-control means onto the disk to cause a poor cleaning effect.

The present invention is also directed to a disk cleaning method and a cleaning apparatus, which can reduce the poor cleaning of disks, easily move the disk into and out of the rinse tank, and increase the cleaning throughput.

As embodied and broadly described herein, the present invention provides a disk cleaning method, a disk immersing and extracting mechanism, and a cleaning apparatus, in which recessed parts of a pair of substrate holding plates for a disk holder and a control bar are used to buckle to the outer edge of a disk, so as to hold the disk. The disk holder comprises a disk support frame having on the upper side a pair of substrate holding plates for forming saw-tooth shaped herringbone teeth, and a control bar. The control bar and the disk support frame are disposed on the upper part of the disk support frame and arranged parallel with each other and spaced apart by a specific distance, and the supported disk is immersed within the liquid. After the disk has been cleaned, the control bar is elevated to a position above the liquid level before moving the disk support frame. On one hand, the control bar is bypassed from the direction in which the disk supported by the disk support frame is not contacted with the dripped liquid droplets, or on the other hand, after the control bar is bypassed, the disk support frame is elevated from the liquid level.

As described hereinafter in the present invention, the disks are held by the disk holder, and the disks are immersed in the rinse tank. The disk holder includes a control bar on the upper side, and a disk support frame, having a pair of substrate holding plates parallel to the control bar, on the lower side. Then, after cleaning, the disks are extracted out of the rinse tank by the disk holder. When extracting the disks, the control bar on the upper side is first elevated to a position above the liquid level, and the control bar on the upper side is bypassed from the upper part of the disks in such a way that the liquid droplets will not drip onto the disks supported by the disk support frame. Under the circumstance that the control bar on the upper side has been bypassed, the disks supported by the disk support frame emerge immediately from the liquid level. Therefore, even if liquid droplets drip from the control bar on the upper side, the disks are not affected.

Furthermore, since the control bar has been bypassed from the upper part of the disks, the space above the upper part of the disk support frame is ensured. The control bar on the upper side will not hinder the motions of the disk chuck, etc. for the handling robot when performing the handling treatment on the disk support frame for moving the disks in and out of the rinse tank. Therefore, the disks are easily being unloaded out of the disk support frame, or the disks to be rinsed thereafter are easily being loaded.

As a result, the disk immersing and extracting mechanism according to the present invention can prevent the disks from floating up or falling over in the rinse tank, and also can prevent liquid droplets from dripping from the floating-control means onto the disks. Hence, a poor cleaning of disks is not easily resulted.

Through utilizing such a disk immersing and extracting mechanism, a disk cleaning method and a cleaning apparatus, which can easily perform the disk handling treatment, can be achieved. Consequently, the unsatisfactory cleaning of the disks is reduced, and the throughput of the cleaning treatment is increased.

In order to achieve the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural diagram of a disk immersing and extracting mechanism using the disk cleaning method according to an embodiment of the present invention.

FIG. 2 is a diagram of the status of the control bar on the upper side of the disk holder viewed from the upper side of FIG. 1.

FIG. 3 is a diagram of the status of the disk support frame on the lower side of the disk holder viewed from the left side of FIG. 1.

FIG. 4 is a flow chart of the disk immersing and extracting actions of the disk immersing and extracting mechanism of FIG. 1.

### DESCRIPTION OF EMBODIMENTS

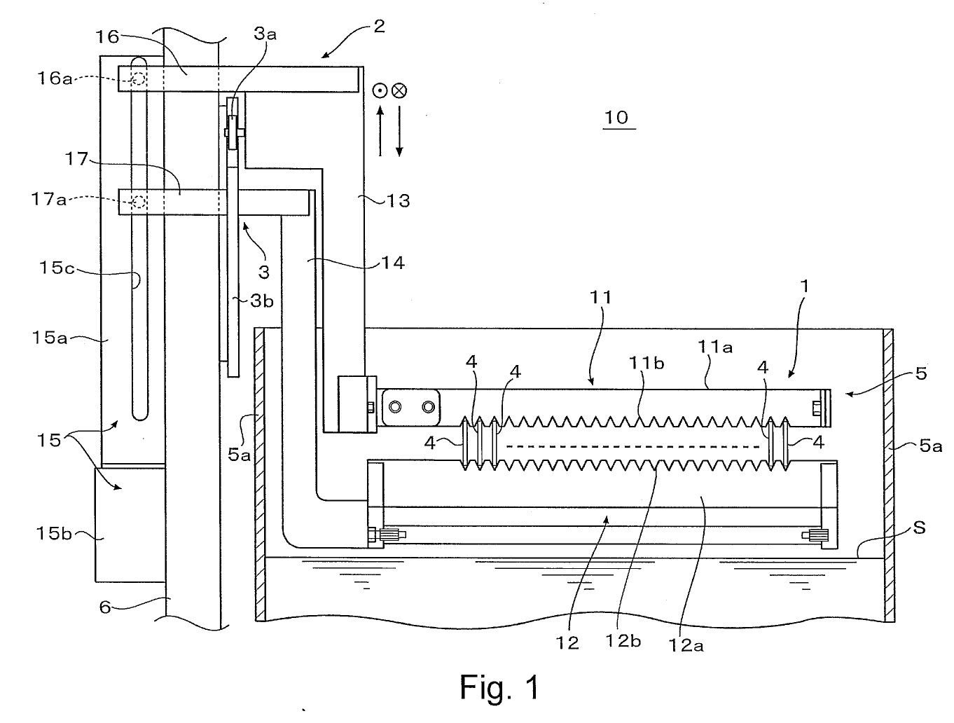

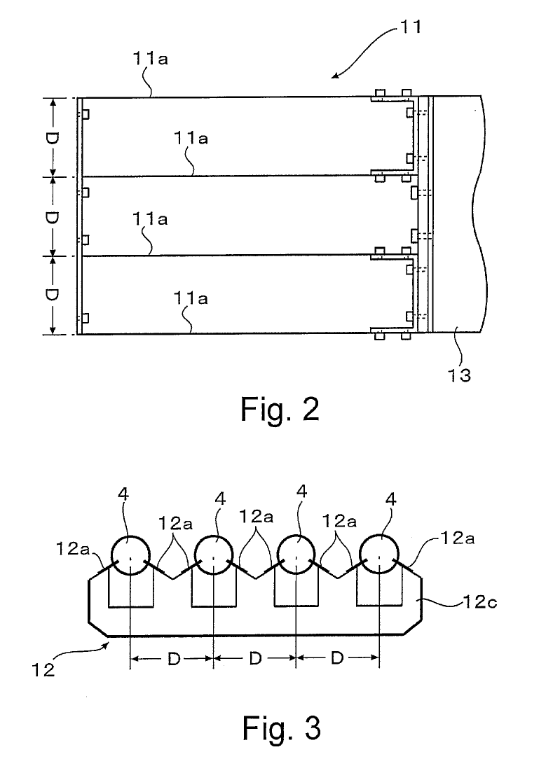

Hereinafter, the preferred embodiments of the present invention are described with reference to the accompanying drawings. FIG. 1 is a schematic structural diagram of a disk immersing and extracting mechanism using the disk cleaning method according to an embodiment of the present invention. FIG. 2 is a diagram of the status of the control bar on the upper side of the disk holder viewed from the upper side of FIG. 1.

In FIG. 1, a disk immersing and extracting mechanism 10 includes a disk holder 1, a holder lifting mechanism 2, a cam mechanism 3, a disk 4 to be cleaned, an ultrasonic rinse tank 5, and a post frame 6. Moreover, an ultrasonic wave generating apparatus, a chemical agent discharging and returning path and a chemical agent feeding and circulating path in the ultrasonic rinse tank 5 are omitted in the diagram.

The disk holder 1 includes a control frame 11 on the upper side and a disk support frame 12 on the lower side. As shown by the dotted line, several disks 4 are held between theses frames and are arranged in an upright pose and spaced apart by a specified distance.

As shown in the plan view of FIG. 2, the control frame 11 is configured as follows. For example, four rows of paralleled tooth plates 11a are disposed as substrate holding plates, with two ends being held by the support frame. That is to say, four rows of tooth plates 11a are disposed in the control frame 11 to serve as substrate holding plates, and they are formed together with the frame into a rectangular lattice. Sawtooth-shaped herringbone teeth 11b are disposed on one side of the lower side (in the vertical direction of FIG. 2) of each tooth plate 11a for forming the control frame 11 in FIG. 1. The herringbone teeth 11b are formed by a continuous combination of approximate triangular protrusions to form the sawteeth configuration. The vertex part (i.e., the front part) of the triangular protrusions can be planar or can maintain as a cute-angle vertex. The front end of the herringbone tooth 11b in FIG. 1 is ground to become flat.

An end means of the control frame 11 is supported and fixed on a lateral-sliding lift bracket 13 of the holder lifting mechanism 2. Therefore, the control frame 11 is moved along with the movement of the lateral-sliding lift bracket 13, and moved up and down in the direction indicated by the up and down arrows (Z-axis direction) in FIG. 1, with respect to the liquid level S of the ultrasonic rinse tank 5, and, as shown by the symbol in FIG. 1, also slides in the lateral direction vertical to the diagram, i.e., in the direction (X-axis direction) along the liquid level S of the cleaning liquid in the ultrasonic rinse tank 5.

As shown in the plan view of FIG. 2, the outer frame of the control frame 11 is also formed by the tooth plate 11a, and herringbone teeth 11b as described above are also formed on each tooth plate 11a. In the control frame 11, the distance of the space between the tooth plates 11a is D, which is set to be larger than the diameter d (external width in the lateral direction) of the disks 4.

FIG. 3 is a diagram of the status of the disk support frame on the lower side of the disk holder viewed from the left side of FIG. 1. As shown in FIG. 3, the disk support frame 12 includes a plurality of tooth plates 12a, which points to the center of the disks 4 held thereon, and inclines for about 60 degrees from the vertical direction. In other words, the adjacent tooth plates 12a are arranged in such a manner that the plates face each other at an angle of about 120 degrees. A pair of tooth plates 12a with disks held thereon is disposed on four rows of bottom bracket 12c as substrate holding plates. The pair of tooth plates 12a is configured as follows, i.e., similar to the tooth plates 11a of the control frame 11 on the upper side of the disk support frame 12, the pair of tooth plates 12a is also arranged in such a manner that the plates face each other at an angle of about 120 degrees, that is, as shown in FIG. 3, when viewed from the front side, a pair of tooth plates 12a of the disk support frame 12 is disposed on both sides at an angle of 120 degrees spaced apart from the tooth plate 11a, and the tooth plates 11a and the pair of tooth plates 12a are buckled to the outer edge of disks 4, so as to hold the disks 4 stably.

Moreover, similar to the herringbone tooth 11b of the control frame 11, the herringbone teeth 12b of the disk support frame 12 are disposed on one side of each tooth plate 12a, and are formed by a continuous combination of approximate triangular protrusions to form the sawteeth configuration. Therefore, the pitch of the herringbone teeth 12b for the disk support frame 12 is the same as that of the herringbone teeth 11a of the control frame 11, so that the plurality of disks 4 can be held in upright pose and spaced apart by a specified distance. Furthermore, as shown in FIG. 3, the distance between the disks 4 in the lateral direction becomes the arranged interspace (distance D) of the tooth plates 11a. In other words, the space between one pair of tooth plates 12a and the next pair of tooth plates 12a is also the arranged interspace (distance) D.

As shown in FIG. 1, same as the control frame 11, the disk support frame 12 has an end being supported and fixed on the lift bracket 14 of the holder lifting mechanism 2, moved along with the movement of the lateral-sliding lift bracket 14, and moved up and down in the direction as indicated by the up arrow in FIG. 1, with respect to the liquid level S of the ultrasonic rinse tank 5.

As mentioned above, the herringbone teeth 11b of each tooth plate 11a and the herringbone teeth 12b of each tooth plate 12a are disposed respectively along the outer edge of the disks 4 and spaced apart by 120 degrees (pitch), and, the plurality of disks 4 is chucked at three points within the recessed parts or the space (distance) between the herringbone teeth.

The holder lifting mechanism 2 includes a lateral-sliding lift bracket 13, a lift bracket 14, and a lift mechanism 15. The lift mechanism 15 includes a Z-axis moving mechanism 15a, a driving mechanism 15b thereof, and a guide groove 15c disposed on the Z-axis moving mechanism 15a.

The lateral-sliding lift bracket 13 is formed into a crank shape bent at an angle of 90 degrees (a reversed L-shaped block), and the end of the control frame 11 is fixed on the low end side in FIG. 1. A cam follower 3a for forming the cam mechanism 3 is disposed on the front end at the side of the minor axis of the reverse L-shape block.

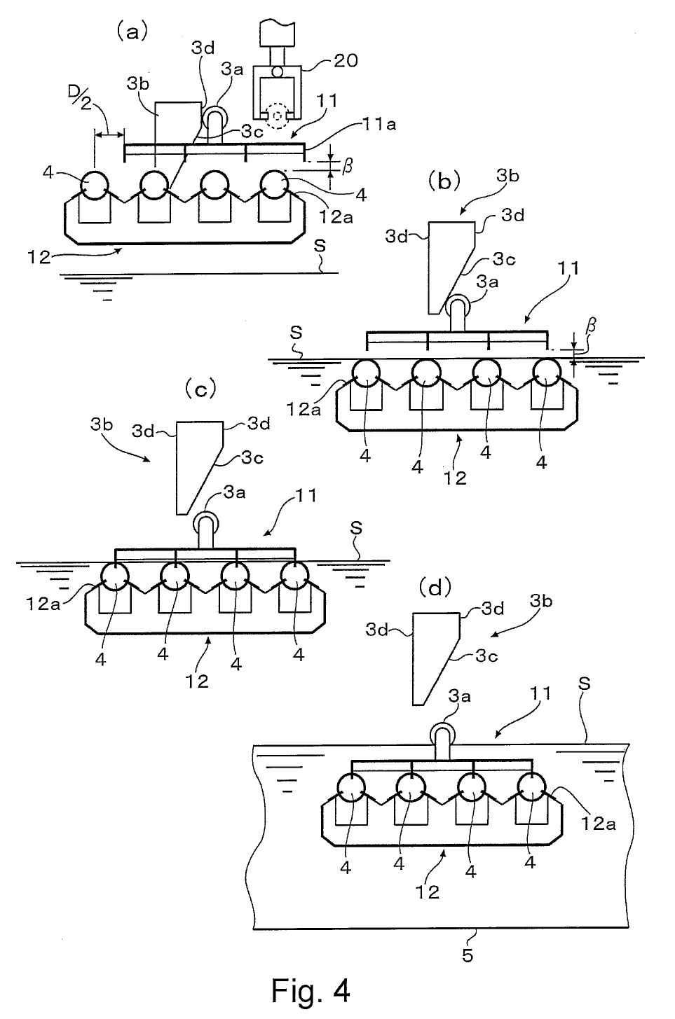

As shown in FIGS. 4(a)-(d), the plate cam 3b is formed into a cam shape and has an inclined plane 3c inclined at about 15 degrees relative to the vertical direction, and a vertical plane 3d.

The lift bracket 14 is formed into a crank shape bent at an angle of 90 degrees (an L-shaped block), and one end of the disk support frame 12 can be fixed on the low end side in FIG. 1. The inner side of the major axis for the L-shaped block of the lift bracket 14 and the inner side of the major axis for the reversed L-shaped block of the lateral-sliding lift bracket 13 are disposed in the manner of facing each other.

The lift mechanism 15 lifts the lateral-sliding lift bracket 13 and the lift bracket 14 to move up and down in the Z-axis direction along the post frame 6 of the disk immersing and extracting mechanism. Additionally, the lateral-sliding lift bracket 13 utilizes a spring (not shown) disposed in the Z-axis moving mechanism 15a to apply an external force to ensure the cam follower 3a and the plate cam 3b to be buckled together while they are sliding.

The plate cam 3b, which is buckled to the cam follower 3a, extends from the outer side of the wall 5a of the ultrasonic rinse tank 5 to the post frame 6 above the wall 5a, and it is disposed at a position above the wall 5a in the manner of facing the wall 5a.

The lateral-sliding lift arm 16 is an element for the lift mechanism 15, with an end of the lift arm 16 being connected along the minor axis side of the reversed L-shaped block of the lateral-sliding lift bracket 13, and with the other end of the lift arm 16 being connected to the Z-axis moving mechanism 15a by means of a rod 16a. The rod 16a can move in the vertical direction (X-axis direction) with respect to the drawing. Thus, the control frame 11 moves up and down in the up and down direction (Z-axis direction) with respect to the liquid level S of the ultrasonic rinse tank 5, and slides in the lateral direction (X-axis direction), vertical to the drawing, of the liquid level S of the cleaning liquid of the ultrasonic rinse tank 5.

The lift arm 17 is an element for the lift mechanism 15 and is disposed on the low side of the lateral-sliding lift arm 16, connected to the front end of the major axis of the L-shaped block of the lift bracket 14, and also connected to the Z-axis moving mechanism 15a by means of a rod 17a.

The lift mechanism 15 can drive simultaneously both the lateral-sliding lift arm 16 and the lift arm 17 to move up and down, and it can also drive separately the lateral-sliding lift arm 16 to move up and down.

The lateral-sliding lift bracket 13 and the lift bracket 14 move up and down by means of using the lift mechanism 15 to respectively drive the lateral-sliding lift arm 16 and the lift arm 17 to move up and down, and thus, the control frame 11 and the disk support frame 12 move up and down under the effect that the lateral-sliding lift bracket 13 and the lift bracket 14 move up and down.

Moreover, FIG. 1 shows the circumstance that the lateral-sliding lift arm 16 and the lift arm 17 are disposed on the front side, and they also can be disposed on the back side in the same manner. In this case, the lateral-sliding lift bracket 13 and the lift bracket 14 are supported from both the front side and the back side of the drawing.

Then, the motions of immersing and extracting the disk in/out of the ultrasonic rinse tank 5 by means of the lift mechanism 15 and the cam mechanism 3 are illustrated below with reference to FIGS. 4(a)-(d).

FIG. 4(a) shows the status that the disk 4 is disposed, in an upright pose, on the disk support frame 12 of the disk holder 1 by a disk handling robot (not shown) using a disk chuck 20. The disk 4 is supported by the recessed part of the herringbone tooth 12b of a pair of tooth plates 12a for the disk support frame 12 and held in an upright pose.

At this time, the cam follower 3a of the cam mechanism 3 is buckled to the upper part of the vertical plane 3d on the top portion of the plate cam 3b.

The lateral-sliding lift bracket 13 slides in the lateral direction, which allows the control frame 11 to move (offset) only for a specified distance of about D/2 from the top point of the disk 4 along the direction (left and right direction in FIG. 4: X-axis direction) of the liquid level S of the chemical agent in the ultrasonic rinse tank 5. As shown in FIG. 4(a), the tooth plates 11a of the control frame 11 are located at positions outside the outer width d (diameter d<D) of the disks 4 held on the disk support frame 12.

The disks 4 are loaded into the disk support frame 12 through the gap between the tooth plates 11a of the control frame 11, i.e., as shown in FIG. 2, through the slit of the arranged interspace D of the tooth plates 11a of the control frame 11. At this time, the disk chuck 20 can dispose the disk into the disk support frame 12 one by one, or a plurality of disk chucks 20 is disposed parallel with each other in the disk handling robot, and a plurality of disks is disposed into the support frame 12 at the same time by the plurality of disk chucks 20. In addition, the disks 4 can be disposed in the disk support frame 12 at the same time by a robot hand with an arm for arranging a plurality of disks in rows and holding them in upright pose.

The width of the disk chuck 20 is smaller than the arranged interspace D of the tooth plate 11a of the control frame 11 shown in the plan view of FIG. 2(b); therefore, the tooth plate 11a of the control frame 11 does not cause any trouble when the disks 4 are loaded into the disk support frame 12 by the disk chuck 20. Furthermore, the lateral width of the arm for arranging the plurality of disks into rows and holding them in upright positions should be smaller than the above arranged interspace D when the arm is used.

Additionally, the disk chuck 20 shown in the drawing or an inner diameter chuck chucks the outer diameter of the disk 4. When the disk chuck 20 chucks the outer diameter of the disk 4, the distance D is: d+α<D, and (d+α) is the outer width when the disk chuck 20 chucks the disk.

The lift mechanism 15 allows both the lateral-sliding lift arm 16 and the lift arm 17 to move downwards simultaneously from the status shown in FIG. 4(a). While they are moving downwards, the disk holder 1 merely supports rather than fixes the disks 4 in the disk support frame 12 in an upright pose. In essence, the front end on the lower part of the tooth plate 11a of the control frame 11 is supported by the disk support frame 12 and is located at a position slightly higher than the top position of the outer edge of the disks 4. In other words, the disk holder 1 has switched from the fixed status for the disks to a slightly suspending status of the control frame 11 with respect to the disk support frame 12.

A slit β exists between the top end of the outer edge of the held disks 4 and the front end of the herringbone teeth 11b of the control frame 11, and the slit β is set to be several millimeters (mm).

Under the circumstance that the slit β is maintained, when the lift mechanism 15 allows both the lateral-sliding lift arm 16 and the lift arm 17 to move downwards simultaneously, the cam follower 3a of the cam mechanism 3 is changed from the status in FIG. 4(a) into a status of contacting with the inclined plane 3c of the plate cam 3b, and the control frame 11 moves from the right to the left along the direction of the drawing. Correspondingly, the control frame 11 moves towards the left of the drawing, and the initial offset D/2 is gradually reduced. Moreover, when the cam follower 3a moves to a position below the inclined plane 3c and stops, the offset becomes zero, and the tooth plate 11a of the control frame 11 moves towards the left of the drawing and reaches the top end of the outline of the disks 4. The above description corresponds to the status shown in FIG. 4(b).

At this time, the can follower 3a of the cam mechanism 3 is located at the front end of the inclined plane 3c, such that the tooth plate 11a of the control frame 11 is substantially located at the top end of the outer edge of the disks 4. The disks 4 loaded into the disk support frame 12 are immersed under the liquid level S of the ultrasonic rinse tank 5, and the top end of the outer edge of the disk 4 is immersed before than the control frame 11. As a result, as shown in FIG. 4(b), the control frame 11 at the suspending status with respect to the disk support frame 12 is located above the liquid level S and spaced apart by the slit β; hence, the liquid level S of the ultrasonic rinse tank 5 is located at a level within the slit β.

The lift mechanism 15 allows the lateral-sliding lift arm 16 to move further downwards from the status shown in FIG. 4(b); thus, the slit β gradually reduces, and the control frame 11 and the disk support frame 12 hold the disks 4 at the status shown in FIG. 1. At this time, the cam follower 3a of the cam mechanism 3 leaves the position on the inclined plane 3 of the plate cam 3b and moves downwards, and the initial status for holding disks in this way is shown in FIG. 4(c).

Then, when both the lateral-sliding lift arm 16 and the lift arm 17 move downwards simultaneously, the tooth plate 11a of the control frame 11 also immerses under the liquid level S, and the cam follower 3a of the cam mechanism 3 further departs from the inclined plane 3c of the plate cam 3b and moves downwards.

The lift mechanism 15 further allows both the lateral-sliding lift arm 16 and the lift arm 17 to move downwards simultaneously; and thus, the disk holder 1 further moves downwards to a lower position under the liquid level S, which is set as a cleaning position. The above description corresponds to the status shown in FIG. 4(d), in which the entire disk holder 1 is disposed in the cleaning position under the liquid level S of the ultrasonic rinse tank 5.

When the ultrasonic cleaning is finished, through a reversed sequence as described above, the control frame 11 and the disk support frame 12 of the disk holder 1 proceeds from the status of FIG. 4(d), through the status of FIG. 4(c), and then the status of FIG. 4(b), and return to the status of FIG. 4(a).

At this time, the reverse sequence is from the status of FIG. 4(c) to that of FIG. 4(b).

At this time, the disks 4 loaded into the disk support frame 12 are located below the liquid level S of the ultrasonic rinse tank 5, and the control frame 11 is located above the liquid level S. The reason for the above circumstance lies in that, as described above, the front end of the lower side of the tooth plate 11a of the control frame 11 is located at a position (space β) slightly higher than the top end of the outline of the disks 4 supported by the disk support frame 12.

Therefore, in the process when the status of FIG. 4(c) is transferred to the status of FIG. 4(b), the tooth plate 11a of the control frame 11 first emerges from the liquid level S, and then, the disks 4 emerge from the liquid level S. Further, at the same time, the control frame 11 begins to move in the direction towards the offset D/2 to be bypassed.

Additionally, in the process when the status of FIG. 4(b) is transferred to the status of FIG. 4(a), the disks 4 are supported by the disk support frame 12 and extracted out of the liquid level S completely. At this time, the control frame 11 has already been located in a position at the offset D/2, which is a middle point of a pair of tooth plates 12a. Furthermore, the dripping of liquid droplets is mainly divided into two circumstances: dripping immediately after the tooth plate 11a of the control frame 11 is elevated out of the liquid level S, and dripping a moment later. As for the circumstance that liquid droplets drip immediately after the elevating motion, for example, being at the status of FIG. 4(b), the disks 4 are still located under the liquid level S of the ultrasonic rinse tank 5, and the disks are not be affected by the dripping of the liquid droplets. As for the circumstance that liquid droplets drip a moment later, for example, being at the status of FIG. 4(a), the front end of the lower side of the tooth plate 11a of the control frame 11 is located in the middle between a pair of tooth plates 12a, and the disks 4 are affected by the dripping of the liquid droplets. As a result, even if the liquid droplets drip from the front end of the lower side of the tooth plate 11a of the control frame 11, the liquid droplets do not drip onto the disks 4; thus, any unsatisfactory cleaning of disks is obviated.

Moreover, since the tooth plates 11a of the control frame 11 are formed into the herringbone teeth, the downward dripping of the liquid droplets on the herringbone teeth ceases relatively sooner. In addition, the liquid droplets are dripped down between the current disk 4 and the next disk 4.

In the above embodiment, as shown in the front view of FIG. 3, in the disk support frame 12, a pair of tooth plates 12a configured slanting towards the center of the supported disk is disposed to serve as substrate holding plates. Taking this circumstance as an example for illustration, when a slit β exists between the front end of the herringbone tooth 11b of the control frame 11 and the top end of the outer edge of the supported disks 4, the control frame 11 dose not help supporting the disks; thus, only the disk support frame 12 is used to support the plurality of disks 4 arranged in rows. If the tooth plate 12a is thicker, and the recessed part of the herringbone tooth 12 is deeper, a pair of tooth plates 12a spaced apart by about 120 degrees can be used to support the plurality of disks 4. However, if the tooth plate 12a is thinner, or the recessed part of the herringbone tooth 12 is shallower, it is difficult for the disk support frame 12 to support the disks 4, and the disks 4 may be at a risk of falling over.

In view of the above, when the plurality of disks 4 arranged in a row are supported merely by the disk support frame 12, the problem that the disks 4 fall over occurs under the condition that the gravity center of the disks 4 is located on the upper part of the supporting point of the herringbone tooth 12a. Therefore, in this case, the angle of the pair of tooth plates 12a can be selected from a range of greater than or equal to 120 degrees and less than or equal to 180 degrees, or additionally, one or more tooth plates 12a are further disposed between the pair of tooth plates 12a. The simplest solution is to dispose an additional tooth plate 12a at a position corresponding to the lowest point of the disks 4, that is, at the approximately middle point of the pair of tooth plates 12a, so that the disks 4 are supported at three points, i.e., the pair of tooth plates 12a and the additional tooth plate 12a.

As illustrated above, in the above embodiments, the control frame 11 slides in the lateral direction by the cam mechanism 3. However, it should be appreciated that the present invention is not limited to a cam mechanism. A common sliding mechanism besides the above-mentioned mechanism also can be used.

Furthermore, in the above embodiments, although the control frame 11 is taken as a frame for illustration, it also can be only a kind of bar. Further, it is not necessary to dispose a substrate holding plate (tooth plate) with herringbone teeth on the control frame 11. In addition, the herringbone teeth of the substrate holding plate may have a top part being flat. Furthermore, the substrate holding plate herein is not limited to be a plate, but also can be a means, which forms recessed parts spaced apart by a specified space on the side surface of a cylindrical bar, so as to form herringbone teeth. Additionally, in the embodiments, the ultrasonic cleaning apparatus is taken as an example. The present invention is not limited to the ultrasonic cleaning apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A disk cleaning apparatus, for cleaning a disk by immersing the disk in a liquid in a rinse tank, comprising:
a rinse tank means, storing a liquid for cleaning;
a disk holding means, contacting to at least three positions of each outer edge of a plurality of disks, so as to hold the disks respectively in upright pose and allows the disks be arranged in a row and spaced apart with a specified interspace, wherein the disk holding means comprises a control bar means, buckled to the top portion of the outer edge of the disks to hold the disks, and a first and a second holding means, buckled to at least two positions on the side means of the outer edge of the disks to hold the disks;
a lift means, for lifting the first and second holding means of the disk holding means to move in an up and down direction of a liquid level in the rinse tank means;
a lift bypass means, for lifting the control bar means of the disk holding means to move in the up and down direction of the liquid level in the rinse tank means, and allowing the control bar means to be bypassed to a bypass position where liquid droplets dripping from the control bar means do not contact with the disks held by the disk holding means; and
a control means, for performing a controlling operation, wherein after the disks have been cleaned, the lift bypass means is first used to elevate the control bar means to a position above the liquid level of the liquid in the rinse tank means, the control bar means is then bypassed to the bypass position, and after the control bar means begins bypassing to a bypass position, the disks held by the disk holding means are elevated from the liquid level of the liquid by the lift means.

2. The disk cleaning apparatus as claimed in claim 1, wherein
the control means uses the lift means to elevate the disks held by the disk holding means from the liquid level of the liquid when the lift bypass means is used to elevate the control bar means to a position above the liquid level of the liquid in the rinse tank means.

3. The disk cleaning apparatus as claimed in claim 1, wherein
after the lift bypass means used to elevate the control bar means to a position above the liquid level of the liquid in the rinse tank means is completed, the control means uses the lift means to elevate the disks held by the disk holding means from the liquid level of the liquid.

4. The disk cleaning apparatus as claimed in claim 1, wherein
the first and second holding means comprise a disk support frame, and the disk support frame has on an upper side thereof a pair of substrate holding plates with at least one row of sawtooth-shaped herringbone tooth;
the control bar means comprises a bar means, and the bar means is disposed in a form of being paralleled and spaced apart by a specified interspace with respect to the disk support frame, and has a sawtooth-shaped herringbone tooth at the lower side;
during the cleaning process, each recessed part of the pair of substrate holding plates and the bar means are buckled to the outer edge of the disk to hold the disk,
besides the cleaning process, each recessed part of the pair of substrate holding plates is buckled to the outer edge of the disk to hold the disk.

5. The disk cleaning apparatus as claimed in claim 1, wherein
the number of the disposed control bar means is more than one;
the pair of substrate holding plates is disposed corresponding to the control bar means;
a space between the adjacent plates for the pair of substrate hold plates is larger than a diameter of the disk, and the bypass position of the control bar means is located approximately at a center of the adjacent plates for the pair of substrate holding plates.

6. The disk cleaning apparatus as claimed in claim 1, wherein
the control bar means is disposed in a manner that the herringbone tooth of the control bar means is substantially vertical, and the pair of the substrate holding plates is disposed in a manner that the herringbone tooth of the pair of substrate holding plates slants at a specified angle with respect to a vertical direction.

7. The disk cleaning apparatus as claimed in claim 1, wherein
the rinse tank comprises an ultrasonic generating apparatus.

8. A disk immersing and extracting apparatus, for immersing a disk into a liquid in a rinse tank, and extracting the cleaned disk out of the rinse tank, comprising:
a disk holding means, buckled to at least three positions on each outer edge of a plurality of disks, so as to hold the disks respectively in upright pose and allow the disks be arranged in a row and spaced apart by a specified interspace, wherein the disk holding means comprises a control bar means, buckled to a top end portion of the outer edge of the disks to hold the disks, and a first and a second holding means, buckled to at least two positions on a side means of the outer edge of the disks to hold the disks;
a lift means, for lifting the first and the second holding means of the disk holding means to move in an up direction and a down direction of a liquid level in the rinse tank;
a lift bypass means, for lifting the control bar means of the disk holding means to move in the up direction and the down direction of the liquid level in the rinse tank, and allow the control bar means be bypassed to a bypass position where liquid droplets dripped from the control bar means do not contact with the disks held by the disk holding means; and
a control means, for performing a controlling operation, wherein after the disks have been cleaned, the lift bypass means is first used to elevate the control bar means to a position above the liquid level of the liquid in the rinse tank means, the control bar means is then bypassed to a bypass position, and after the control bar means begins to bypass to the bypass position, the disks held by the disk holding means are elevated from the liquid level of the liquid by the lift means.

9. The disk immersing and extracting apparatus as claimed in claim 8, wherein
the control means concurrently uses the lift means to elevate the disks held by the disk holding means from the liquid level of the liquid when the lift bypass means is used to elevate the control bar means to a position above the liquid level of the liquid in the rinse tank means.

10. The disk immersing and extracting apparatus as claimed in claim 8, wherein
after the lift bypass means used to elevate the control bar means to a position above the liquid level of the liquid in the rinse tank means is completed, the control means uses the lift means to elevate the disks held by the disk holding means from the liquid level of the liquid.

11. The disk immersing and extracting apparatus as claimed in claim 8, wherein
the first and second holding means comprise a disk support frame, and the disk support frame has on an upper side thereof a pair of substrate holding plates with at least one row of sawtooth-shaped herringbone tooth;
the control bar means comprises a bar means, and the bar means is disposed parallelled and spaced apart by a specified interspace with respect to the disk support frame, and has a sawtooth-shaped herringbone tooth at the lower side;
during the cleaning process, each recessed part of the pair of substrate holding plates and the bar means is buckled to the outer edge of the disk to hold the disk, except for the cleaning process, each recessed part of the pair of substrate holding plates is buckled to the outer edge of the disk to hold the disk.

12. The disk immersing and extracting apparatus as claimed in claim 8, wherein
a number of the disposed control bar means is more than one, and the pair of substrate holding plates is disposed corresponding to the control bar means, and a space between the adjacent plates for the pair of substrate hold plates is larger than a diameter of the disk, and the bypass position of the control bar means is located approximately at a center of the adjacent plates for the pair of substrate holding plates.

13. The disk immersing and extracting apparatus as claimed in claim 8, wherein
the control bar means is disposed in a manner that the herringbone tooth of the control bar means is substantially vertical, and the pair of substrate holding plates is disposed in a manner that the herringbone tooth of the pair of substrate holding plates slants at a specified angle with respect to the vertical direction.

14. A disk cleaning method, in which an entire disk holding means is immersed within the liquid of the rinse tank, to clean a plurality of disks simultaneously, and the disk holding means is buckled to at least three positions of each outer edge of the plurality of disks, and the disks are held in an upright pose, arranged in a row and spaced apart by a specified interspace, wherein:
after the disks have been cleaned, the control bar means buckled to the top portion of the outer edge of the disks to hold the disks is first elevated to a position above the liquid level of the liquid, the control bar means is then bypassed to a bypass position where the disks held by the disk holding means are obviated from being contact with liquid droplets dripped from the control bar means, and then the disks held by the disk holding means are elevated from the liquid level of the liquid after the control bar means begins to bypass to the bypass position.

15. The disk cleaning method as claimed in claim 14, wherein
while the control bar means is bypassing to the bypass position, the disks held by the holding means are elevated from the liquid level of the liquid.

16. The disk cleaning method as claimed in claim 14, wherein
after the control bar means is bypassed to the bypass position, the disks held by the disk holding means are elevated from the liquid level of the liquid.
